(19) United States
(12) Patent Application Publication
(10) Pub. No.: US 2015/0118378 A1
(43) Pub. Date: Apr. 30, 2015

(54) VERTICAL BROILER

(71) Applicant: ENODIS CORPORATION, New Port Richey, FL (US)

(72) Inventors: Douglas S. JONES, New Port Richey, FL (US); Janice M. K. JAFERIAN, Palm Harbor, FL (US)

(21) Appl. No.: 14/526,001

(22) Filed: Oct. 28, 2014

Related U.S. Application Data
(60) Provisional application No. 61/896,503, filed on Oct. 28, 2013.

(51) Int. Cl. A47J 37/06; A23L 1/01

(52) U.S. Cl. CPC A47J 37/0688; A23L 1/01; A23V 2002/00
USPC 426/523; 99/443 C

(57) ABSTRACT

The grill of the present disclose cooks a food product in a substantially vertical direction. A chute can supply a food product to two rotating belts that grip the food product between them, and pass it between opposing heaters or burners that are also substantially vertically oriented. The food product is cooked on both sides simultaneously, and the belts apply grill or char marks to the food product. Food product can also be monogrammed or branded on one or both sides with text, symbols or letters. Drippings from the food product can be collected without interfering with operation of the burners. The grill can be operated at pyrolytic temperatures to be self-cleaning.

### CROSS-REFERENCE TO RELATED APPLICATIONS

The present application claims priority to U.S. Provisional Patent Application No. 61/896,503, filed on Oct. 28, 2013, which is herein incorporated by reference.

### BACKGROUND OF THE DISCLOSURE

1. Field of the Disclosure

The present disclosure relates to devices for rapidly grilling or charbroiling food products. More particularly, the present disclosure relates to such grilling devices that orient and cook the food products in a vertical direction.

2. Description of the Related Art

There is a continuing need to improve the efficiency of cooking grills in retail food establishments, and to improve the quality and consistency of the food products produced by the same. Current devices require a lot of manual maintenance, cleaning, and operation, which greatly slows output down. The present disclosure addresses these concerns.

Some current devices attempt to cook food products in a vertical direction. In the device shown in U.S. Pat. No. 8,109,205, to Winer et al., a user manually places a food product in a grilling case, and then manually places the cage inside a box where the food product is cooked. This is undesirable because it is very inefficient. It requires a significant amount of manual labor, which in turn reduces production. U.S. Pat. No. 5,499,574, to Esposito, and European Patent Application No. EP 0 069 187, to Arrigo, are each similarly limited in that the food product must be manually loaded into a cooking rack, and then further manually loaded into a cooking area. In U.S. Pat. No. 6,109,169, to Masel et al., a food product is placed between two vertical platens and cooked. A user has to manually activate the device by throwing a lever to move the platens together. Again, this is inefficient because of the manual labor required. The device of Masel is also unnecessarily cumbersome and unwieldy, because of the mechanism required to drive the plates toward one another. The device of Masel is further limited in that only grill plates may be used, which limits the types of cooking that can take place, and eliminates the ability to place char or grill marks on the food product.

Accordingly, there is a need for a grill that addresses these deficiencies.

### SUMMARY OF THE DISCLOSURE

The present disclosure provides a grill where a food product is introduced to the grill and cooked in a substantially vertical orientation. This allows for simultaneous cooking of both sides of the food product, significantly reducing cooking time. Since the food product is substantially vertical and cooked by heaters or burners that are also substantially vertically aligned, as the food moves between the heaters in the cooking zone any food or grease drippings run off the food and into an unheated area below the food zone. There, it is collected in a bin or trough, and does not contact the burners. This eliminates a significant amount of maintenance and the need to cover or protect the burners.

Thus, in one embodiment, the present disclosure provides a grill comprising a housing, two opposing rotating food transporting belts, chains, or the like, so that there is a gap between the belts, and two heating elements, one associated with each of the belts, wherein the belts and the heating elements are within the housing. The grill further comprises an entry port on one side of the housing, an exit port on an opposite side of the housing, and a chute (or other food dispensing device) in communication with the entry port. A food product is introduced to the housing via the chute and the entry port. The belts grip and move the food product along a longitudinal axis of the housing in the gap. The food product is heated by the heating elements, and transported out through the exit port. The belts are aligned so that the food product is in a substantially vertical orientation within the housing. The belts sear the food product with at least one of a grill mark, a monogram, text, a symbol, and a brand on at least one side of the food product.

The present disclosure also provides a method of cooking a food product, comprising aligning the food product in a substantially vertical orientation, passing the food product between a pair of opposing heaters, so that each side of the food product is cooked simultaneously, and moving the food product to a collection area after it passes between the pair of heaters.

### BRIEF DESCRIPTION OF THE DRAWINGS

FIG. 1 shows a perspective rendering of the grill of the present disclosure;

FIG. 2 shows a rendering of the grill of the present disclosure in a countertop application;

FIG. 3 shows a perspective rendering of the grill of the present disclosure with the housing removed;

FIG. 4 shows a perspective line drawing of the grill of the present disclosure;

FIG. 4A shows a perspective view of a belt of the grill of FIG. 4, with food products thereon;

FIG. 4B shows a perspective view of an alternative embodiment of the belts of the grill of the present disclosure;

FIG. 4C shows a perspective view of a third embodiment of the belts of the grill of the present disclosure;

FIG. 4D shows a perspective view of the belts of FIG. 4C being removably connected to the grill of the present disclosure.

FIG. 5 shows the grill of FIG. 4, with one of the rotating belts removed;

FIG. 6 shows the grill of FIG. 5, with one of the rotating belts and two of the belt towers removed;

FIG. 7 shows the grill of FIG. 6, with one of the heaters removed; and

FIG. 8 shows a side view of the grill of FIG. 7.

### DETAILED DESCRIPTION OF THE DISCLOSURE

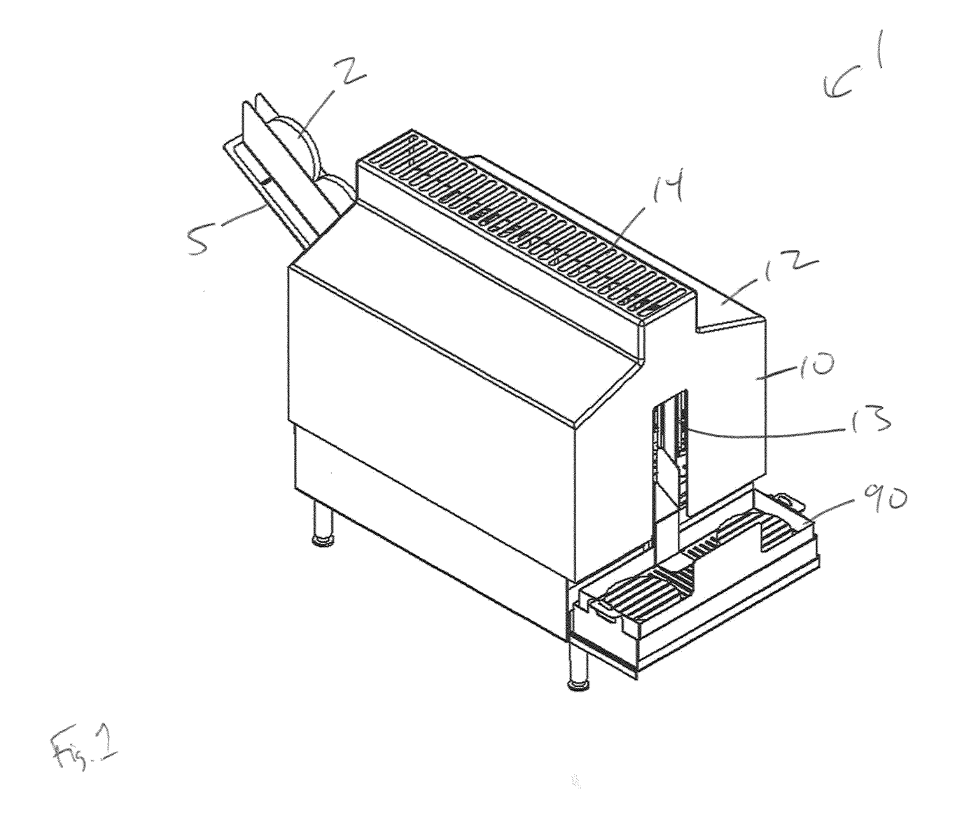

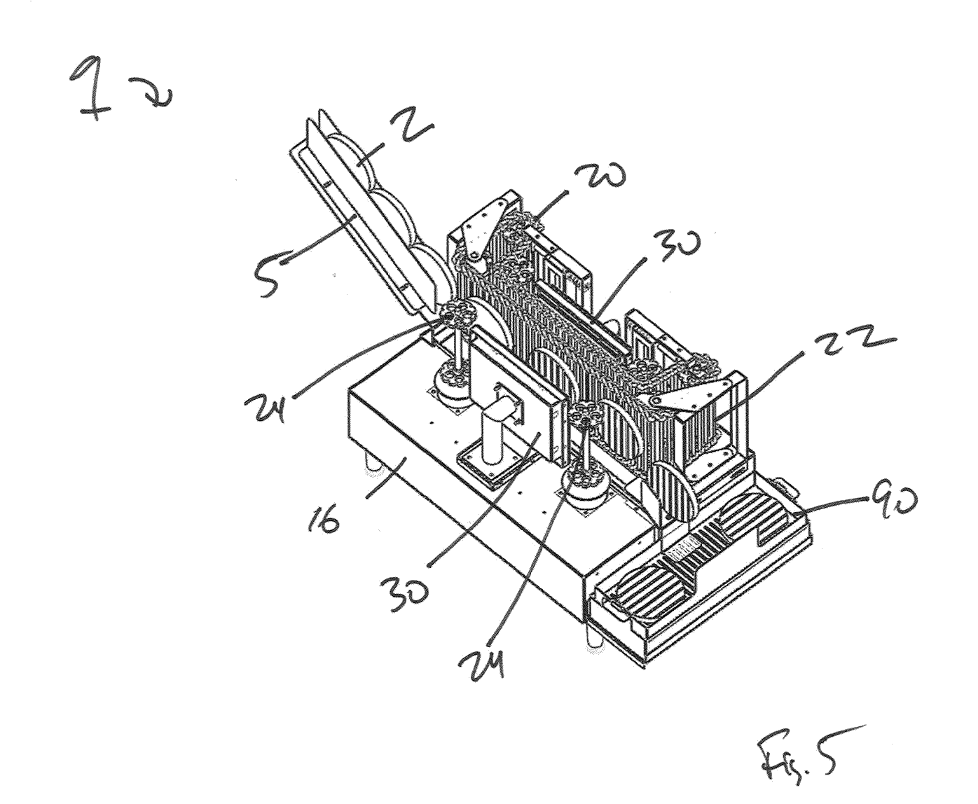

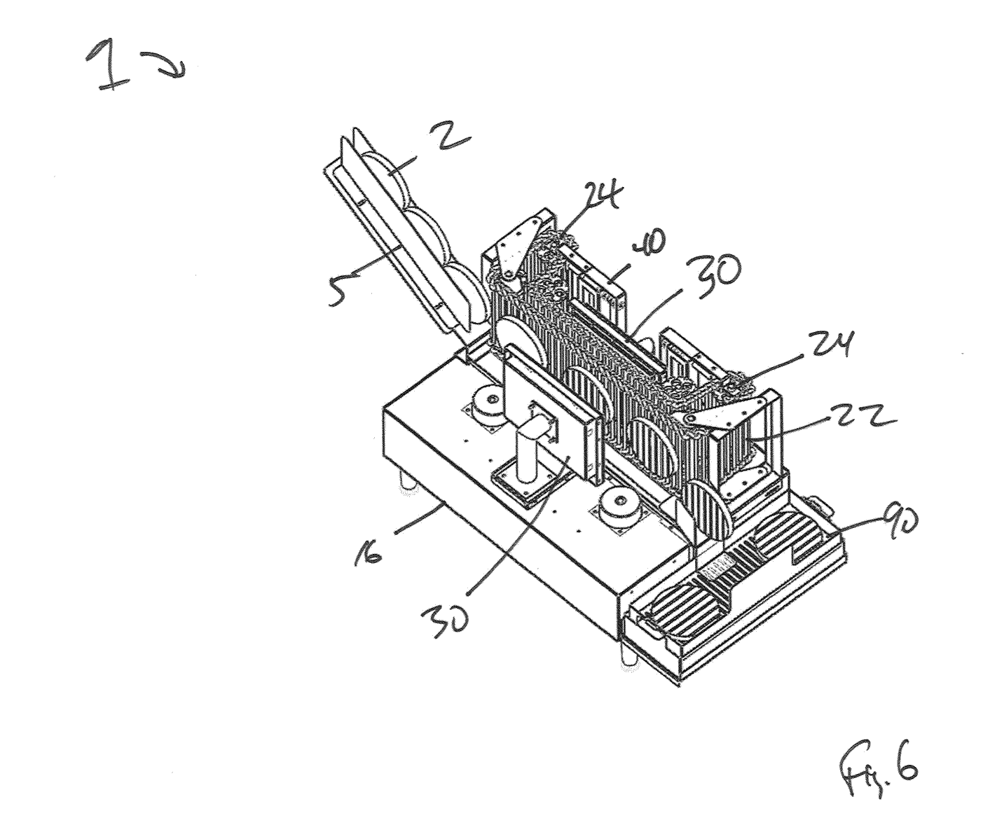

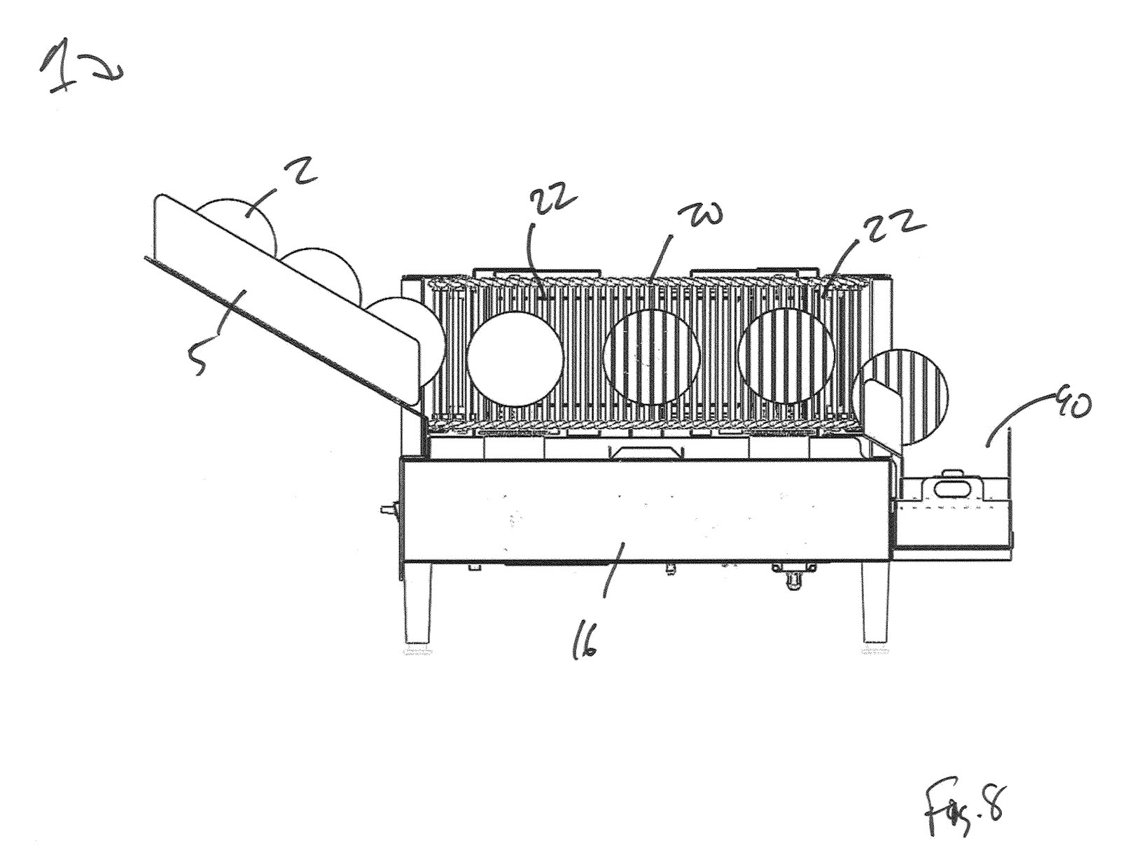

Referring to FIGS. 1-8, grill 1 of the present disclosure is shown. Grill 1 has loading chute 5, heating section 10, and collection area 90. Food products 2 (in the shown embodiment circular hamburger patties) are placed into chute 5, which orients products 2 in a substantially vertical direction. Products 2 are gripped by belts 20, which carry products 2 through heating section 10 in a substantially vertical orientation. Food product 2 is cooked simultaneously by heating elements 30, within heating section 10, all while being held in the substantially vertical orientation. Heating elements 30 are also substantially vertically aligned. As discussed in greater detail below, belts 20 are heated prior to the point at which they pass food product 2 in front of heating elements 30, which starts the cooking process before food product 2 is presented to heating elements 30. Belts 20 sear food product 2 before, while, and after they present food product 2 to heating elements 30. After it is cooked, belts 20 carry product 2 to collection area 90, where it can be picked up by a user. Alternatively, a food conveying mechanism or system can move the food to a finishing area, or a food dispensing area or mechanism.

Food products 2 of the present disclosure can be aligned in a perfectly vertical orientation, i.e. one where product 2 is perpendicular to the horizontal plane. Food products 2 can also “substantially” vertical, i.e. oriented slightly off perpendicular. The present disclosure contemplates that food products 2 can be oriented anywhere from parallel to the horizontal plane to perpendicular thereto, or any sub ranges there between.

Three-dimensional food products will typically have three axes along which they can be measured, namely a length, width, and thickness or depth. In some food products, the length and width will be approximately the same, such as with circular or square hamburger patties. Other food products will have a generally rectangular solid shape, where the length and width across one side of the food product are both larger than its thickness, for example a chicken cutlet. By “vertical orientation”, the present disclosure means that one of the larger two dimensions, namely the length or width of the food product, is in a substantially vertical orientation. For example, when the food product is a circular hamburger patty, the length and width will be approximately equal, and will correspond to the dimension across the diameter of the face of the patty. As shown in the accompanying Figures, this length or width is in a substantially vertical orientation.

The present disclosure contemplates that the food product can be perfectly vertical, i.e. perpendicular to the horizontal plane. The food product can also be an angle to the vertical axis, for example from zero up to forty-five degrees from vertical, or any subranges therebetween. The food product can also be from zero up to ninety degrees from vertical, or any subranges therebetween, wherein ninety degrees from the vertical is horizontal. In embodiments where a chute is used to introduce the food product, as discussed in greater detail below, the chute can be in a substantially vertical orientation, so that the food product is also aligned vertically when in the chute. “Substantially” vertical means either perfectly vertical, or slightly off toward the horizontal.

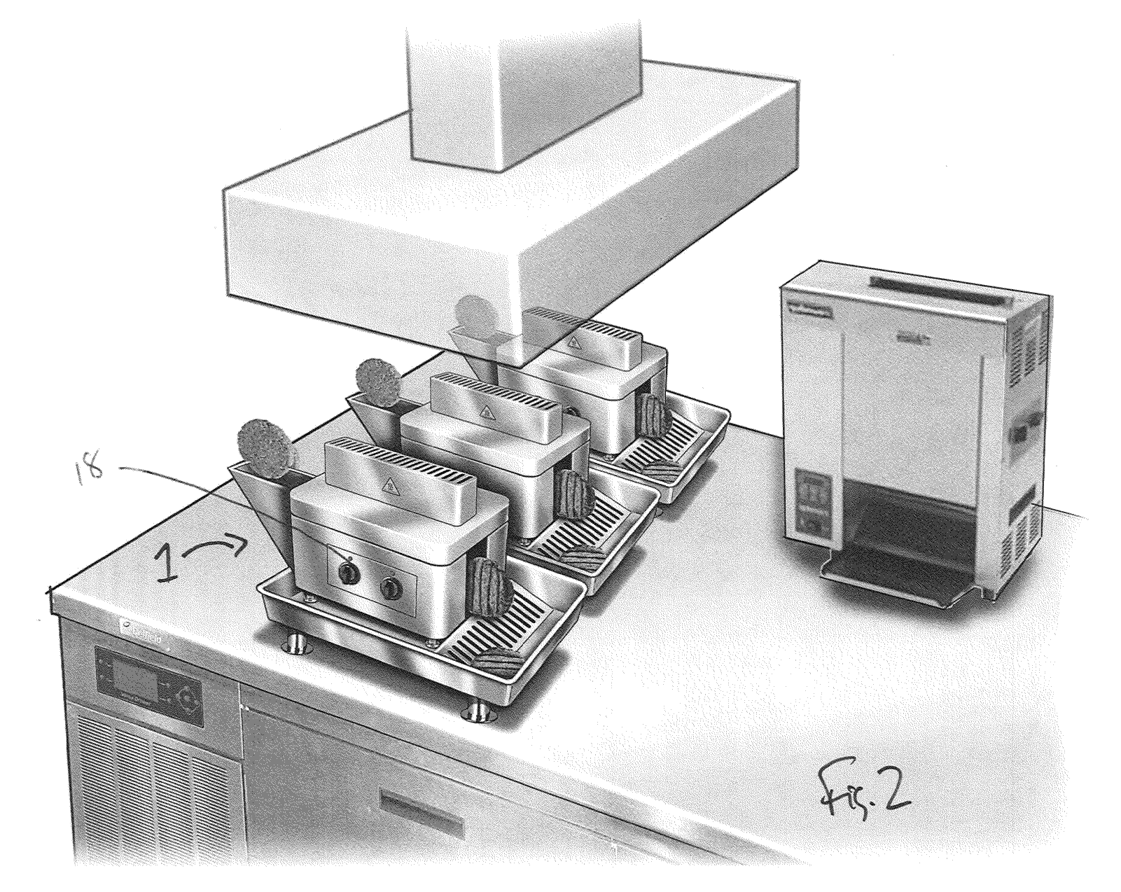

Grill 1 provides several advantages not provided for by current devices. Since food product 2 is in a substantially vertical direction while being cooked, any grease or food drippings fall off toward the bottom of grill 1. This prevents grease or food drippings from hitting heating elements 30, which are also in a substantially vertical orientation, and also eliminates the need to protect heating elements with covers, as is done in current devices. Multiple food products 2 can be stacked in chute 5 for cooking, allowing the user to perform other tasks while cooking is taking place. The vertical cooking orientation of grill 1 also allows for a small, portable, table-top footprint (FIG. 2), which makes it easier to use in cooking establishments. Food product 2 could also be automatically loaded into chute 5 from a large volume holding unit. Another advantage of the substantially vertical cooking orientation is that fat does not accumulate on the surface of the cooked food product but rather drips off, leaving a healthier and more appealing final cooked product.

As discussed in greater detail below, belts 20 can be made of any one of the following materials: heavy gauge wire, porous or non-porous metal or ceramic mesh, non-porous metal or ceramic plates, or perforated metal or ceramic sheets. Some of these materials will create grill marks on food product 2, which can be desirable from a consumer or owner standpoint. As both sides of product 2 are cooked and marked simultaneously, there is no need to flip food products 2. This provides grill marks on both sides of product 2 where applicable, and also significantly reduces the cooking time. Some current devices do not have any provision for flipping food products, meaning that the cooked products only have marks on one side. Belts 20 can also be heated to a point at which they become self-cleaning, eliminating a significant amount of maintenance required for grill 1. These are all significant advantages of grill 1 as compared to currently available devices.

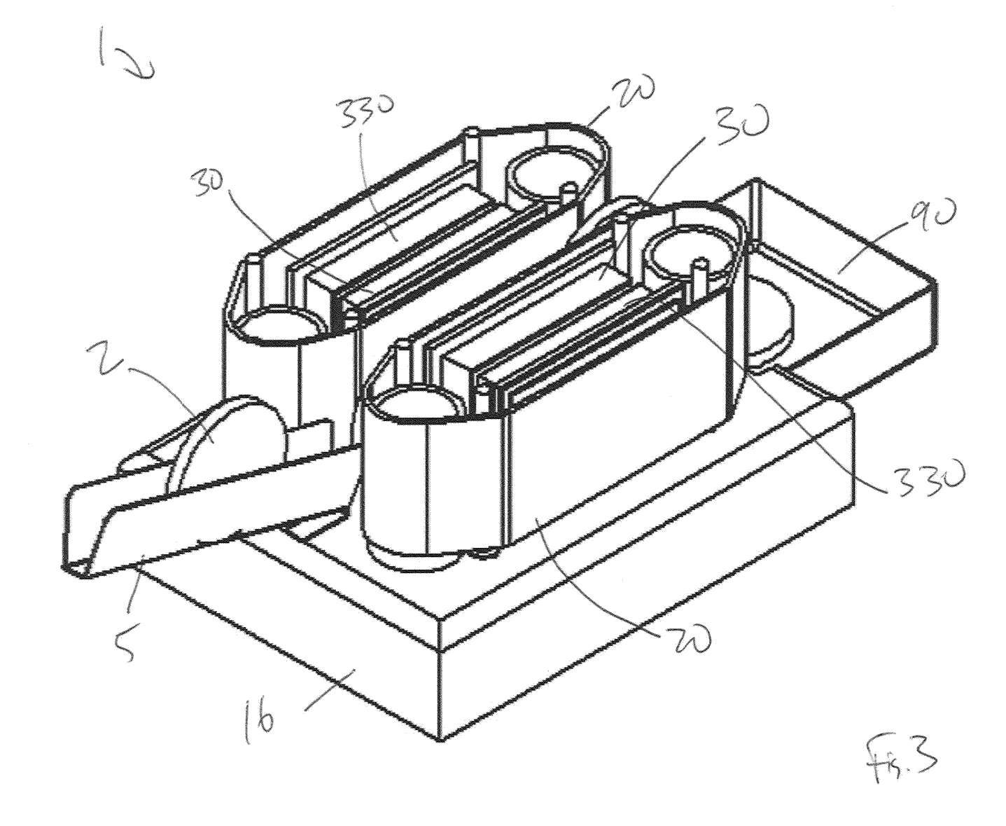

Referring again to the Figures, and in particular FIG. 3, after the user loads product 2 into chute 5, it is gripped by belts 20 at the bottom of chute 5. Belts grab food product 2 therebetween, and draw product 2 into and along the length of heating section 10. In the shown embodiment, there are two belts 20, each of which is made of heavy gauge wires 22 that are spaced apart. Within heating section 10 are also two heating elements 30 (or electric infrared heaters, not shown), each of which corresponds to one of belts 20. Each of belts 20 are continuously circulated around the corresponding burner 30. Food product 2 is cooked when belts 20 pass it in front of heating elements 30.

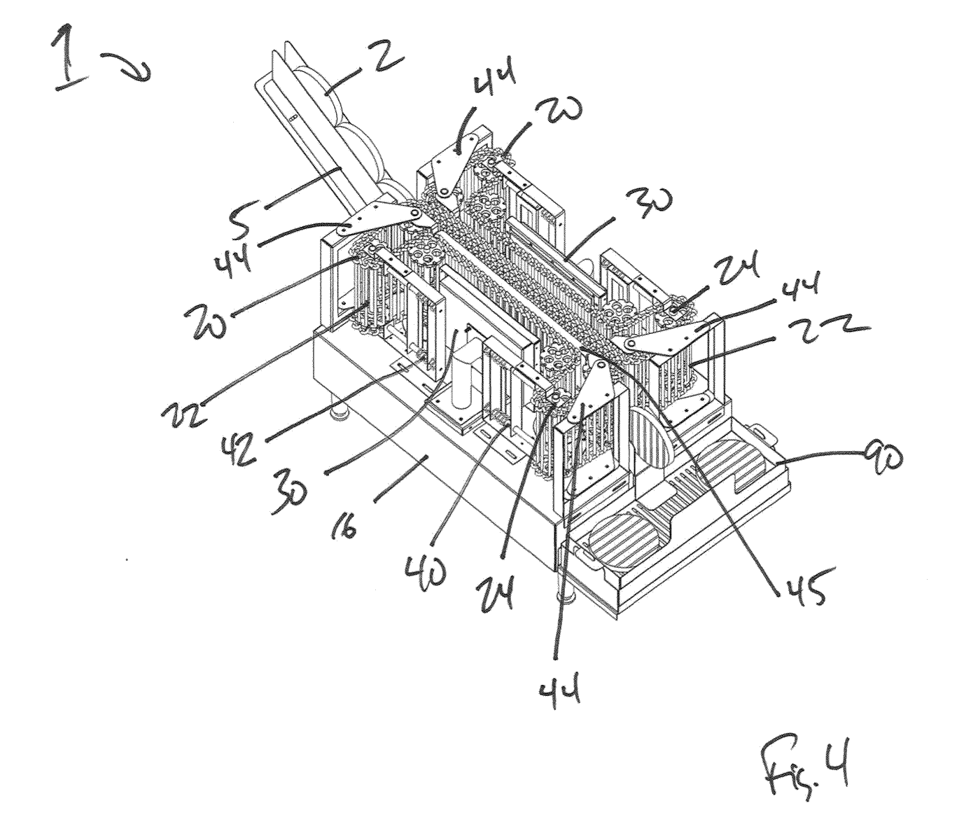

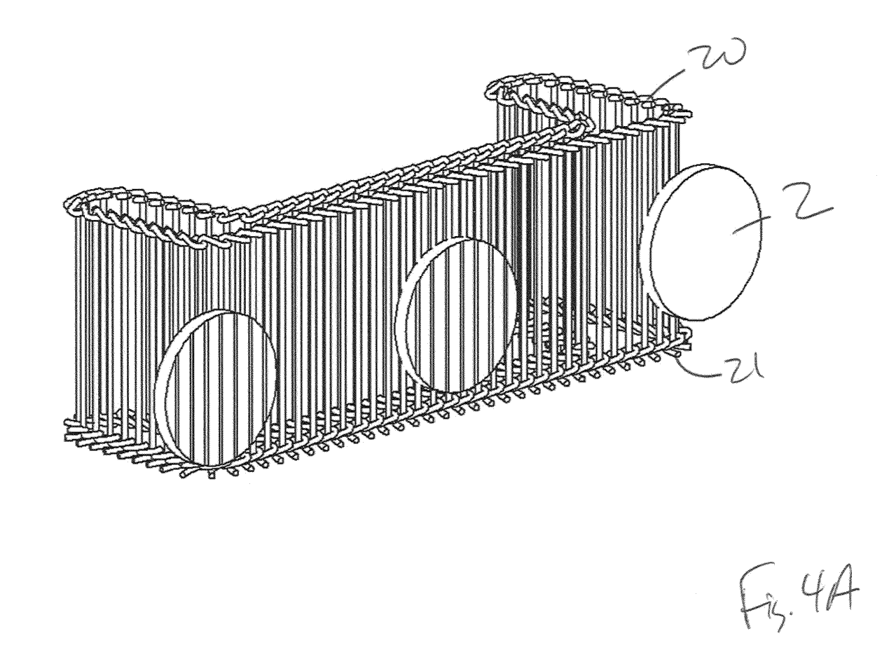

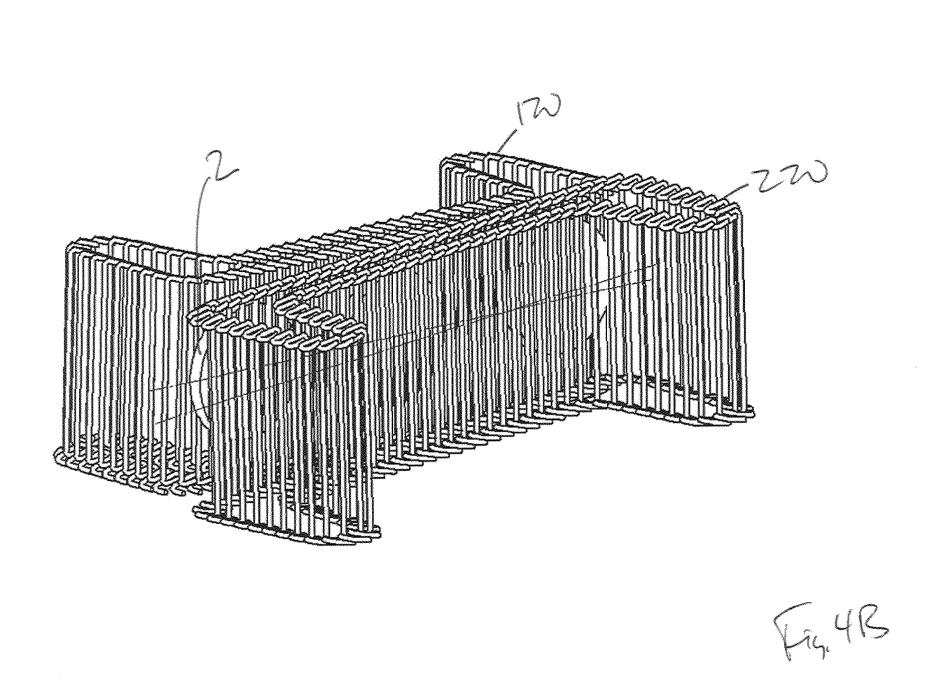

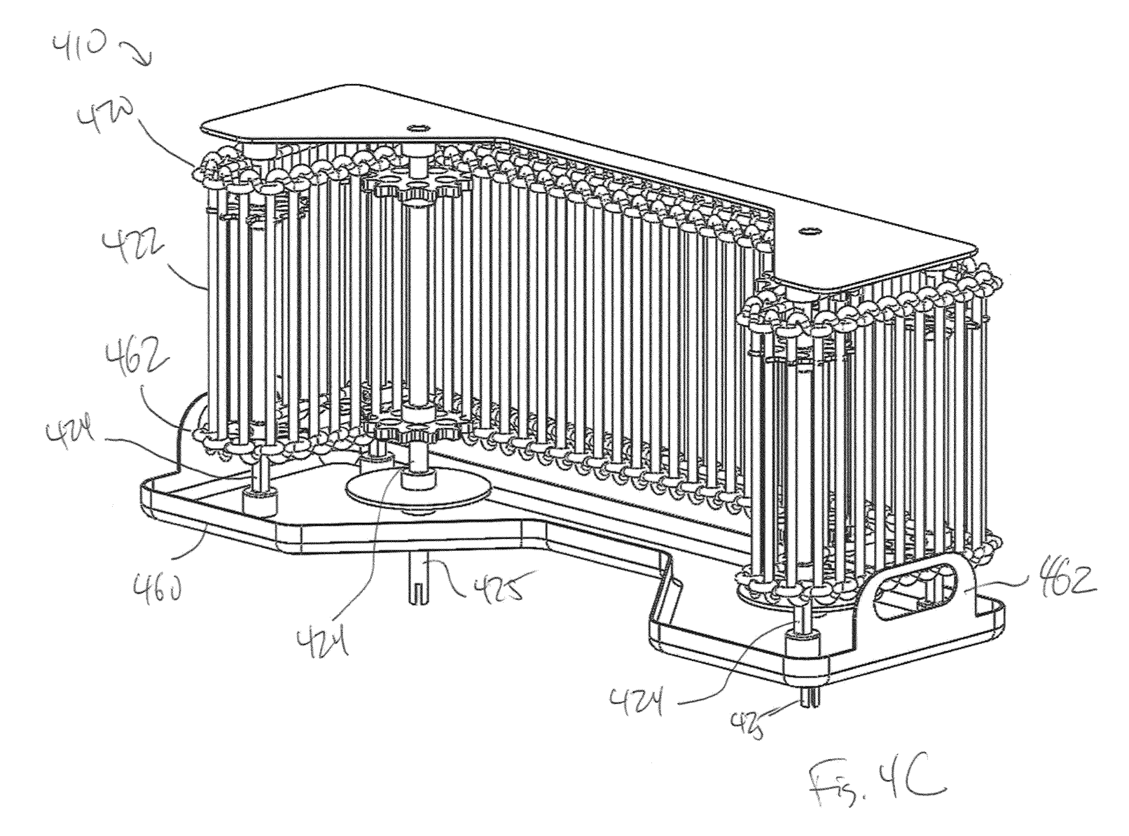

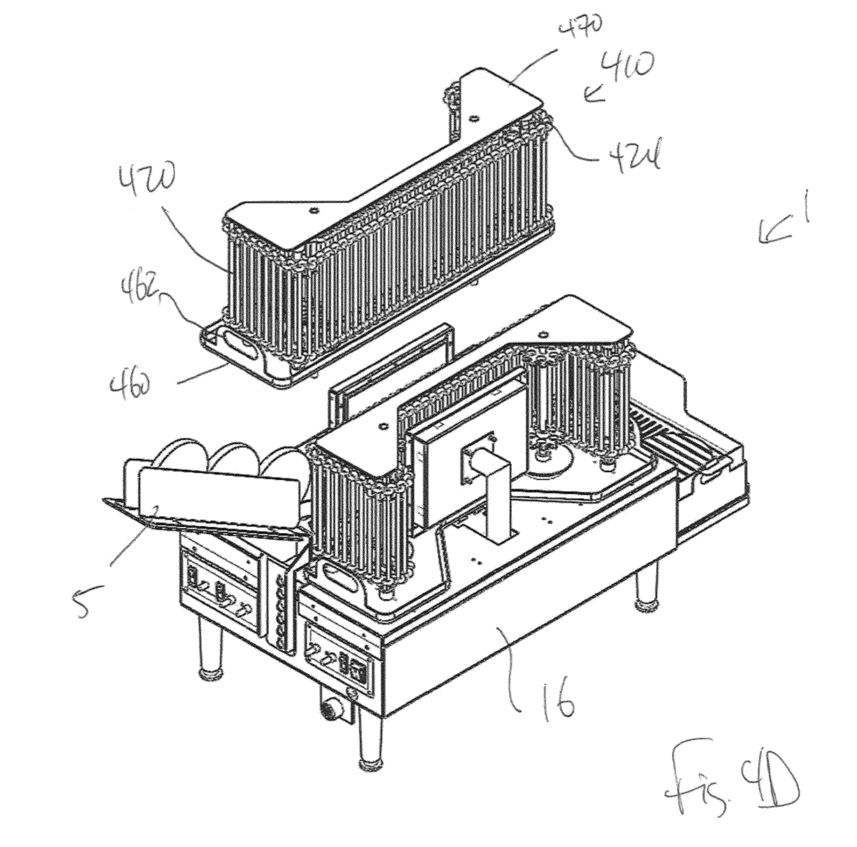

In the shown embodiment, belts 20 are shown as having an open configuration, with wires 22 separated by gaps. This serves at least two advantageous functions. First, belts 20 and wires 22 apply distinctive char marks to food product 2, which is desirable for consumers and retailers alike. The open configuration of belts 20 also facilitates the transfer of heat and infrared energy to food product 2. In addition, when belts 20 only make one pass by heaters 30 (as shown in FIGS. 4), an open belt configuration is advantageous. In other embodiments, when a second set of burners 330 are used just to heat belts 30 (as shown in the rendering of FIG. 3), then belts 20 could have a more closed configuration. Belts 20 can be linked by gears or chains. A single drive motor can operate each of belts 20, so that they are driven at the same speed.

Belts 20 can also be designed to have a brand or monogramming portion built in, so that they impart text, a logo, or other characters on to food product 2. For example, belts 20 can have words, symbols or text, an initial monogram, or a company logo thereon, so that cooked food product 2 bears that text, monogram, or logo. This monogramming portion can be part of the material of belts 20, or integrated into the design of belts 20. For example, the monogramming portion can be made of the same material that forms wires 22. The monogramming portion can be made in sections that would enable the monogramming or branding portion of belt 20 to bend around the curved part of the pathway of belt 20, but would be relatively solid or single-piece appearing while traveling along the straight portion of the pathway, so that during the cooking process the monogram or brand is seared onto one or more surfaces of the cooked food product.

Also, by continuously rotating around heating elements 30 within heating section 10, belts 20 are maintained at a high temperature. Thus, when food product 2 is picked up by belts 20, each of wires 22 makes a sear or char mark on the surface of food product 2. Char marks are a desirable feature in the food retail industry and for consumers. The temperature of belts 20 can be set to any appropriate cooking temperature for cooking the food in the middle cooking zone. When belts 20 return back to a cooking starting point, they pass close to heating elements 30, which heat belts 20 to sufficiently pyrolytic temperature, cleaning off any residual material left on the belts during cooking. In one embodiment, the temperature of belts 20 is from seven hundred to eight hundred degrees Fahrenheit, or any subranges therebetween. This is a suitable range for ensuring prompt cooking of food product 2 and applying sufficient char marks to the same during the amount of time product 2 is within heating section 10. Again, due to the fact that belts 20 are maintained at these high temperatures, they can be self-cleaning of any food or grease particulates that adhere thereto during the cooking process. This is another advantageous feature of grill 1.

Heating or cooking food product 2 on two sides simultaneously greatly reduces the time needed for cooking. In traditional devices, where only one side of the product is cooked at a time, the cooking times can be several minutes, for example 3-4 minutes. With grill 1, the cooking time can be reduced to sixty to ninety seconds, or any subranges therebetween, required to cook the particular food product. Cooking times with grill 1 can be half or less than those of conventional cooking methods.

Referring specifically to FIGS. 4-7, grill 1 can have a spring-loaded or other width-adjusting mechanism that controls a distance between belts 20 as they are guiding product 2 through heating section 10. The distance or gap between each of belts 20 will need to be varied to accommodate different products 2, as well as different thicknesses of the same. For example, when product 2 is a beef patty, vendors may sell different sizes or thicknesses of cooked hamburgers to their customers. Poultry products such as chicken patties or bone-in cuts will have different thicknesses as well. Advantageously, grill 1 can accommodate a variety of sizes of food products 2.

Belts 20 can be held in place by and rotate around a plurality or gear towers 24. In the shown embodiment, the gap- or width-adjusting mechanism described above includes idler rollers 44 that are mechanically or manually placed at a desired location to produce a desired gap between belts 20. In one embodiment, as shown, there is a pair of idler rollers 44 for each of belts 20. Spring tensing assemblies 40 and springs 42 maintain the belt tension by keeping belts 20 from sagging. One or more belt backing bars 45 can hold belts 20 at the desired gap throughout the cooking zone within heating section 10, between an entry and exit port (discussed in greater detail below) for food product 2. Other methods may be used to control and maintain the compression placed on food product 2 while it is cooked within grill 1.

The spacing of belts 20 can also be automated so that a control system, product recognition program, sensors, or set of controls detects or sets the appropriate gap itself. A user can also set the desired gap through controls on grill 1, or by selecting a certain food type. Belts 20 can also have a fixed gap, or an auto-adjusting spring loaded gap. In the latter, the thickness of food product 2 controls the gap width, as a spring tensioned pressure will lightly press the belt onto the food as it passes through the unit.

Advantageously, grill 1 allows significant flexibility in types of food product 2 that can be cooked, as well as whether food product 2 is frozen or at room temperature when initially delivered from chute 5. When food product 2 is delivered into chute 5, it may initially stick to belts 20, but as it goes through the cooking process, it will release. Food product 2 will still have enough structural integrity so that it does not fall apart when deposited collection area 90 after cooking is complete.

As food product 2 is cooked, it may shrink in thickness. Grill 1 can taper the distance or gap between belts 20 so that it is smaller at the end of heating section 10 opposite chute 5 (or vice versa), which allows belts 20 to maintain a tighter grip on product 2. In addition, as shown in FIG. 4A, grill 1 may have a horizontal lip or guide 21 on one or both of belts 20. If food product 2 were to slip down in a vertical direction due to shrinkage or because of getting slick from food grease, lip or guide 21 would hold it at a fixed vertical position until belts 20 ejected it from heating section 10.

Referring to FIG. 4B, an alternative embodiment of belts 20 is shown. In this embodiment, belts 120 and 220 are aligned at a slight angle to one another with respect to the horizontal axis, i.e. the axis along which food product 2 travels. Belts 120 and 220 function in a similar manner as belts 20 described herein, and food product 2 is cooked in the same fashion. As previously discussed, food product 2 may stick to belts 20 at the time it is picked up at chute 5, but it will typically release from belts 20 by the time it hits exit 13. This is due to the effects of cooking, which shrink product 2, and release juices or oils in product 2. There may be some instances, however, where food product 2 remains stuck to one or both of belts 20 even after cooking. The advantage to using belts 120 and 220, and mounting them at a slight horizontal angle to one another, is that this arrangement provides additional assurance that food product 2 will be released. Since belts 120 and 220 are slightly misaligned, they impart a force on food product 2 in a vertical as well as horizontal direction, which helps to ensure that product 2 is released at the proper time.

Belts 20 and any accompanying width-adjusting mechanisms (such as rollers 44 discussed below) can be removably connected to base 16 of grill 1, for ease of cleaning and maintenance. Belts 20 and the width-adjusting mechanisms can also be part of a cassette or assembly that is removably connected to base 16, so that belts 20 and the width-adjusting mechanisms are removed at once. An example of such an assembly is shown in FIGS. 4C and 4D, and is referred to by reference numeral 410. Belt assembly 410 has belt 420, with heavy gauge wires 422, and also one or more gear towers 424, which function in a similar fashion to belt 20, wires 22, and towers 24 discussed above. Assembly 410 also has lower connection plate 460, which holds belt 420 and towers 424 together so they can be removably connected to base 16, as shown in FIG. 4D. Towers 424 can have projections 425 that pass through plate 460, and connected with motors (not shown) within base 16. Base plate 460 can have one or more handles 462 to assist a user in removing assembly 410 from base 16. Assembly 410 can also have upper plate 470. Upper plate 470 also to secure belts 420 and towers 424 in place, so that assembly 410 holds belt 420 and towers 424 securely at two separate locations.

Heating elements 30 can be any suitable type or design of heater that can apply heat to product 2 as it passes in front of them. In one embodiment, heating elements 30 are forced draft combustion burners. These burners can be particularly suitable, because the forced air directs flames and combustion gases directly toward food product 2. This effect gives distinctive char marks to food product 2, heats food product 2 with a combination of convection and infrared heating, and decreases the cooking time. The present disclosure also contemplates that heating elements 30 can be ambient combustion burners, i.e. those burners that do not use blowers or forced drafts. Heating elements 30 can also be electric or any type of infrared burners, such as ceramic infrared burners. The heating surface of heating elements 30 can be a metal or ceramic mesh, or steel wool. This heating surface can be heated by combustion gases or other type of heat from elements 30, and then transfer heat to product 2. Heating elements 30 can have an output of from three thousand to fifty thousand British thermal units (BTU)/hr, or any subranges therebetween. In one embodiment, heating elements 30 have a variable heat input that can be adjusted to accommodate different food and different belt speeds.

Belts 20, heating elements 30, and spring mechanism 40 can all be within housing 12 of heating section 10. Housing 12 envelops each of these components and protects them from environmental conditions. Housing 12 also protects a user from direct contact with the hot surfaces of belts 20 or heating elements 30. Housing 12 can have two ports or slots 13 on either side thereof, one at the end of chute 5, and the other at the opposite end adjacent to collection area 90. As discussed above, food product 2 is introduced into heating section through the first of slots 13, via chute 5, and exits through the slot 13 on the other side of housing 12. Having each of belts 20, heating elements 30, and the spring mechanism all within housing 12 provides a convenient, counter-top unit of grill 1, as shown in FIGS. 1 and 2. When the belts 20 and heating elements 30 are within housing 12, any workers using grill 1 are at least partially protected from food vapors or high temperatures.

Housing 12 can have a vent 14 on a top surface thereof. Vent 14 may be over a hole (not shown) in housing 12, so that heated air and grease vapors may be expelled through vent 14. Vent 14 may also contain catalysts (not shown) to absorb smoke, grease, and other vaporized exhaust from within housing 12. The catalysts used must be suitable for use at high temperatures, and for removing smoke and cooking particulates.

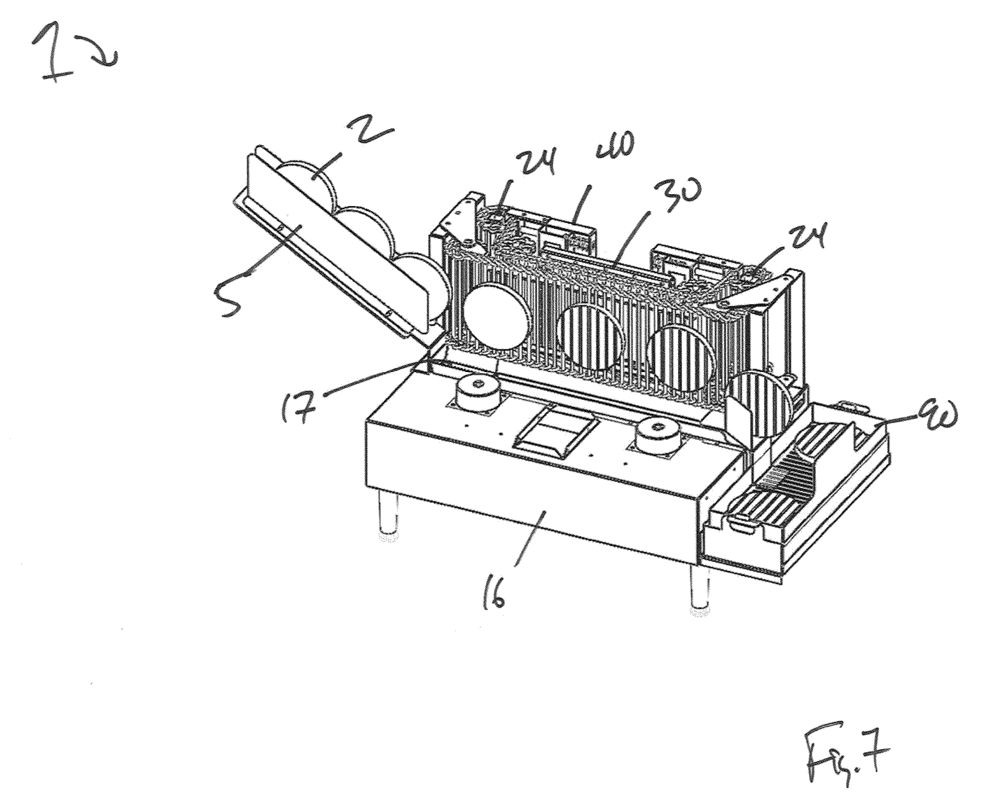

Housing 12 can also have a base 16, where controls and power equipment for belts 20, heating elements 30, and other components of grill 1 can be stored. On the top of base 16 is groove 17 (FIG. 7), which can act like a grease collection zone and catches drippings from product 2 as it passes through heating section 10. Groove 17 can drain the drippings to collection area 90, where they can be cleaned out. Housing 12 can also be removed to service and clean any of the components therein. Groove 17 or collection area 90 can also hold a volume of water to keep the grease and drippings from heating above their ignition point, thus reducing flare-ups.

As shown in FIG. 1, housing 10 can have one or more control dials or other user interface devices 18 on an exterior surface thereof. Dials or user interface devices 18 can allow the user to adjust or set the speed of belts 20, the output of heat used in grill 1, or other features relating to the cooking of food products 2. Dials or user interface devices 18 can also be used simply to select a type of food (e.g., chicken, beef, lamb, pork), and a control system (not shown) in grill 1 will match and set the cooking parameters (belt speed, heat output) accordingly.

Food products 2 can be introduced to heating section manually by stacking them in chute 5. Grill 1 can also be operated by interfacing it with one or more of the following: an automated mechanism to feed products 2 to grill 1, a collection apparatus for collecting cooked products 2, a station for assembling and/or dispensing a fully assembled retail product using cooked food product 2 (e.g., a hamburger with a bun and toppings made with a hamburger patty cooked by grill 1), and a point of sale (POS) system to allow a customer or operator select the type of food product that is cooked and prepared. Thus, in one embodiment, when grill 1 is used in a retail food establishment, a customer can place an order at the POS station for a particular type of food product 2. A control system (not shown) can receive the order from the POS system, and control a feeding mechanism to send the appropriate product 2 to chute 5. After product 2 has been cooked in grill 1, the product can be conveyed automatically with a collection apparatus to a station (not shown) for further assembly into the final product. In this fashion, grill 1 could be integrated into a fully automated product assembly system. Grill 1 may also be used in conjunction with an automated feeder and/or a collection apparatus alone.

While the present disclosure has been described with reference to one or more particular embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this disclosure.

1. A grill, comprising:
a housing;
two opposing rotating belts, so that there is a gap between said belts;
two heating elements, one associated with each of said belts, wherein said belts and said heating elements are within said housing;
an entry port on one side of said housing;
an exit port on an opposite side of said housing; and
a chute in communication with said entry port,
wherein a food product is introduced to said housing via said chute and said entry port, and wherein said belts grip and move said food product along a longitudinal axis of the housing in said gap, where the food product is heated by said heating elements, and transported out through said exit port, and
wherein said belts are aligned so that the food product is in a substantially vertical orientation within said housing, and
wherein said belts sear the food product with at least one of a grill mark, a monogram, text, a symbol, and a brand on at least one side of the food product.

2. The grill of claim 1, further comprising a mechanism in communication with said belts, so that a width of said gap can be controlled by said mechanism.

3. The grill of claim 3, wherein said mechanism is a spring.

4. The grill of claim 1, wherein each of said belts comprises a material selected from the group consisting of heavy gauge wires, porous metal mesh, porous ceramic mesh, non-porous metal, non-porous ceramic, and perforated metal.

5. The grill of claim 4, wherein said belts comprise heavy gauge wire.

6. The grill of claim 1, wherein said heating elements are selected from the group consisting of forced draft combustion burners, atmospheric combustion burners, electric heaters, metal infrared heaters, and ceramic infrared burners.

7. The grill of claim 6, wherein said heating elements are forced draft combustion burners.

8. The grill of claim 1, further comprising at least two gear towers associated with each of said belts, wherein rotation of said gear towers causes movement of said belts.

9. The grill of claim 8, wherein said grill further comprises a base, and at least one of said belts and said gear towers are removably connected to said base.

10. The grill of claim 9, wherein at least one of said belts and said gear towers are part of a cassette that is removably connected to sais base of said grill.

11. The grill of claim 1, wherein at least one of said belts includes a monogramming or branding portion, to impart said grill mark, monogram, text, or brand on said food product.

12. A method of cooking a food product, comprising:
aligning the food product in a substantially vertical orientation;
passing said food product between a pair of opposing heaters, so that each side of the food product is cooked simultaneously; and
moving the food product to a collection area after it passes between said pair of heaters.

13. The method of claim 12, wherein the food product is passed between said heaters with a pair of opposing belts.

14. The method of claim 13, further comprising the step of adjusting a gap between said pair of opposing belts.

15. The method of claim 13, further comprising the step of imparting grill marks on at least one side of the food product without flipping the food product.

16. The method of claim 13, further comprising the step of imparting at least one of a grill mark, a monogram, text, and a brand on to at least one surface of the food product without flipping the food product.

17. The method of claim 12, further comprising the step of rotating said belts back toward said heaters, close enough to clean off any of the remaining food by heating said belts up to pyrolitic temperatures.

18. A method of cooking a food product, comprising the step of cooking the food product with the grill of claim 1.

19. The method of claim 18, further comprising the step of adjusting a gap between said pair of opposing belts

20. The grill of claim 1, wherein the heating elements are set at a temperature sufficient to heat said belts to pyrolitic temperatures that clean off residue that may remain on said elements after a cooking process.
